(19) United States
(12) Patent Application Publication
(10) Pub. No.: US 2020/0288526 A1
(43) Pub. Date: Sep. 10, 2020

(54) RADIO LINK STATUS DETERMINATION METHOD AND RADIO LINK STATUS DETERMINATION DEVICE

(71) Applicant: BEIJING XIAOMI MOBILE SOFTWARE CO., LTD., Beijing (CN)

(72) Inventor: Xiaowei JIANG, Beijing (CN)

(73) Assignee: BEIJING XIAOMI MOBILE SOFTWARE CO., LTD., Beijing (CN)

(21) Appl. No.: 16/883,808

(22) Filed: May 26, 2020

Related U.S. Application Data
(63) Continuation of application No. PCT/CN2017/113660, filed on Nov. 29, 2017.

(51) Int. Cl. H04W 76/18; H04W 76/19; H04W 24/08; H04W 72/04; H04W 74/08

(52) U.S. Cl. CPC H04W 76/18; H04W 76/19; H04W 74/0833; H04W 72/0453; H04W 24/08

(57) ABSTRACT

Methods and devices are provided for determining a radio link status. In the method, the device determines whether there is a first radio link failure on a supplemental uplink carrier of a cell in which the supplementary uplink carrier is configured. The device determines whether there is a second radio link failure on a non-supplemented uplink carrier. When at least one of the first radio link failure or the second radio link failure occurs, the device determines that the cell has the radio link failure, and initiates a connection reestablishment procedure, and/or transmits information on radio link failure to a base station.

### CROSS-REFERENCE TO RELATED APPLICATIONS

This application is continuation of International Application No. PCT/CN2017/113660, filed on Nov. 29, 2017, the entire content of which is incorporated herein by reference in its entirety for all purposes.

### TECHNICAL FIELD

The present application generally relates to the technical field of communications, and more particularly, to a radio link status determination method, a radio link status determination device, an electronic device and a computer-readable storage medium.

### BACKGROUND

In long term evolution (LTE) system, user equipment may monitor a radio link condition of a cell and perform processing in case of a radio link failure (RLF) of a carrier of the cell.

In new radio (NR), a supplement uplink (SUL) carrier is introduced to enhance uplink coverage. Moreover, the SUL carrier does not independently correspond to a cell but is paired with a non-SUL carrier for correspondence to a cell.

However, a conventional radio link monitoring (RLM) manner in LTE system is not suitable to a cell configured with the SUL carrier.

### SUMMARY

According to a first aspect of the present disclosure, a radio link status determination method is provided. The method may include following steps. The device determines whether an RLF occurs to at least one of a SUL carrier of a cell configured with the SUL carrier or a non-SUL carrier. In response to the RLF occurring to at least one of the SUL carrier or the non-SUL carrier, the device determines that the RLF occurs to the cell, and the device may initiate a connection reestablishment flow and/or transmit information of the RLF to a base station.

According to a second aspect of the present disclosure, a radio link status determination device is provided. The device may include anon-transitory storage medium and at least one processor. The at least one processor is configured to determine whether an RLF occurs to at least one of a SUL carrier of a cell configured with the SUL carrier or a non-SUL carrier. In response to the RLF occurring to at least one of the SUL carrier or the non-SUL carrier, the at least one processor is configured to determine that the RLF occurs to the cell, and perform at least one of initiating a connection reestablishment flow or transmitting information of the RLF to a base station.

### BRIEF DESCRIPTION OF THE DRAWINGS

In order to describe the technical solutions in the embodiments of the present application more clearly, the accompanying drawings required to be used for descriptions about the embodiments will be simply introduced below. It is apparent that the accompanying drawings described below are only some embodiments of the present application. Those of ordinary skill in the art may further obtain other accompanying drawings according to these accompanying drawings without creative work.

FIG. 1 is a schematic flow chart showing a radio link status determination method, according to an example of the present disclosure.

FIG. 2 is a schematic flow chart showing determination of an RLF, according to an example of the present disclosure.

FIG. 3 is another schematic flow chart showing determination of an RLF, according to an example of the present disclosure.

FIG. 4 is another schematic flow chart showing determination of an RLF, according to an example of the present disclosure.

FIG. 5 is another schematic flow chart showing determination of an RLF, according to an example of the present disclosure.

FIG. 6 is another schematic flow chart showing determination of an RLF, according to an example of the present disclosure.

FIG. 7 is another schematic flow chart showing determination of an RLF, according to an example of the present disclosure.

FIG. 8 is another schematic flow chart showing determination of an RLF, according to an example of the present disclosure.

FIG. 9 is another schematic flow chart showing determination of an RLF, according to an example of the present disclosure.

FIG. 10 is a schematic flow chart showing initiation of a connection reestablishment flow and/or transmission of information of an RLF to a base station, according to an example of the present disclosure.

FIG. 11 is a schematic flow chart showing initiation of a connection reestablishment flow and/or transmission of information of an RLF to a base station, according to another example of the present disclosure.

FIG. 12 is a schematic flow chart showing another radio link status determination method, according to an example of the present disclosure.

FIG. 13 is a schematic block diagram of a radio link status determination device, according to an example of the present disclosure.

FIG. 14 is a schematic block diagram of a determination module, according to an example of the present disclosure.

FIG. 15 is a schematic block diagram of another determination module, according to an example of the present disclosure.

FIG. 16 is a schematic block diagram of another determination module, according to an example of the present disclosure.

FIG. 17 is a schematic block diagram of another determination module, according to an example of the present disclosure.

FIG. 18 is a schematic block diagram of a processing module, according to an example of the present disclosure.

FIG. 19 is a schematic block diagram of another processing module, according to an example of the present disclosure.

FIG. 20 is a schematic block diagram of another radio link status determination device, according to an example of the present disclosure.

FIG. 21 is a schematic block diagram of a radio link status determination device, according to an example.

### DETAILED DESCRIPTION

The technical solutions in the embodiments of the present application will be clearly and completely described below in combination with the accompanying drawings in the embodiments of the present application. It is apparent that the described embodiments are not all embodiments but only part of embodiments of the present application. All other embodiments obtained by those of ordinary skill in the art based on the embodiments in the present application without creative work shall fall within the scope of protection of the present application.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” and the like may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

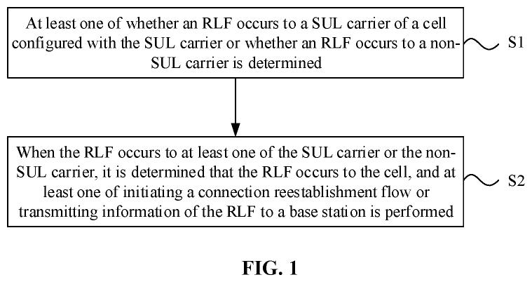

FIG. 1 is a schematic flow chart showing a radio link status determination method, according to an example of the present disclosure. The radio link status determination method in the example may be applied to user equipment, for example, a mobile phone, a tablet computer, a wearable device, and the like. As illustrated in FIG. 1, the radio link status determination method may include the following steps.

In S1, at least one of whether an RLF occurs to a SUL carrier of a cell configured with the SUL carrier or whether an RLF occurs to a non-SUL carrier is determined.

In one or more embodiments, for the SUL carrier and the non-SUL carrier, whether the RLF occurs may be determined respectively.

Take the SUL carrier as an example, an out-of-sync number and in-sync number of the SUL carrier may be monitored to determine whether the RLF occurs to the SUL carrier, or whether random access initiated to the SUL carrier fails may be judged to determine whether the RLF occurs to the SUL carrier.

Take the non-SUL carrier as an example, an out-of-sync number and in-sync number of the non-SUL carrier may be monitored to determine whether the RLF occurs to the non-SUL carrier, or whether random access initiated to the non-SUL carrier fails may be judged to determine whether the RLF occurs to the non-SUL carrier.

The above manner of monitoring the out-of-sync number and the in-sync number to determine whether the RLF occurs and the above manner of judging whether the random access fails to determine whether the RLF occurs will be described in the following examples in detail.

In one or more embodiments, a lower limit value of a band corresponding to the SUL carrier may be less than a lower limit value of a band corresponding to the non-SUL carrier, and an upper limit value of the band corresponding to the SUL carrier may be less than an upper limit value of the band corresponding to the non-SUL carrier.

In S2, when the RLF occurs to at least one of the SUL carrier or the non-SUL carrier, it is determined that the RLF occurs to the cell, and at least one of initiating a connection reestablishment flow or transmitting information of the RLF to a base station is performed.

In one or more embodiments, under the circumstance that the RLF occurs to the SUL carrier, it may be determined that the RLF occurs to the cell configured with the SUL carrier.

In one or more embodiments, under the circumstance that the RLF occurs to the non-SUL carrier, it may be determined that the RLF occurs to the cell configured with the SUL carrier.

In one or more embodiments, under the circumstance that the RLF occurs to the SUL carrier and the RLF occurs to the non-SUL carrier, it may be determined that the RLF occurs to the cell configured with the SUL carrier.

In one or more embodiments, under a normal circumstance, when it is determined that the RLF occurs to the cell, it may be determined to initiate the connection reestablishment flow, or transmit the information of the RLF to the base station, or not only initiate the connection reestablishment flow but also transmit the information of the RLF to the base station according to whether the cell is a PCell or a PSCell.

Based on the example illustrated in FIG. 1, whether the RLF occurs to the SUL carrier and whether the RLF occurs to the non-SUL carrier may be determined for the cell configured with the SUL carrier respectively, and a determination result of the SUL carrier and a determination result of the non-SUL carrier may be integrated to determine whether the RLF occurs to the cell configured with the SUL carrier, so as to further ensure that the user equipment may accurately determine whether the RLF occurs to the cell configured with the SUL carrier, perform appropriate processing and ensure a good communication effect.

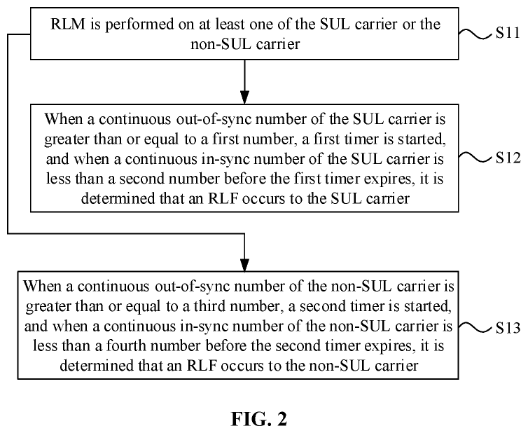

FIG. 2 is a schematic flow chart showing determination of an RLF, according to an example of the present disclosure. As illustrated in FIG. 2, based on the example illustrated in FIG. 1, the operation that the at least one of whether the RLF occurs to the SUL carrier of the cell configured with the SUL carrier or whether the RLF occurs to the non-SUL carrier is determined includes the following steps.

In S11, RLM is performed on the at least one of the SUL carrier or the non-SUL carrier.

In S12, when a continuous out-of-sync number of the SUL carrier is greater than or equal to a first number, a first timer is started, and when a continuous in-sync number of the SUL carrier is less than a second number before the first timer expires, it is determined that the RLF occurs to the SUL carrier; and/or

in S13, when a continuous out-of-sync number of the non-SUL carrier is greater than or equal to a third number, a second timer is started, and when a continuous in-sync number of the non-SUL carrier is less than a fourth number before the second timer expires, it is determined that the RLF occurs to the non-SUL carrier.

In one or more embodiments, a relationship of the first number, the second number, the third number and the fourth number may be set as required. For example, two of the four numbers may be set to be the same, or all the four numbers may be set to be different.

In one or more embodiments, the RLM is performed on the at least one of the SUL carrier or the non-SUL carrier.

Take the SUL carrier as an example, a physical layer may indicate the monitored continuous out-of-sync number OOS1 of the SUL carrier, and when OOS1 is greater than or equal to the first number, the timer may be started for timing. During timing of the timer, the SUL carrier is continued to be monitored, the physical layer may indicate the monitored continuous in-sync number IS1 of the SUL carrier, and when the number IS1 is less than the second number before the timer expires, it is determined that the RLF occurs to the SUL carrier.

Take the non-SUL carrier as an example, the physical layer may indicate the monitored continuous out-of-sync number OOS2 of the non-SUL carrier, and when OOS2 is greater than or equal to the third number, the timer may be started for timing. During timing of the timer, the non-SUL carrier is continued to be monitored, the physical layer may indicate the monitored continuous in-sync number IS2 of the non-SUL carrier, and when the number IS2 is less than the fourth number before the timer expires, it is determined that the RLF occurs to the non-SUL carrier.

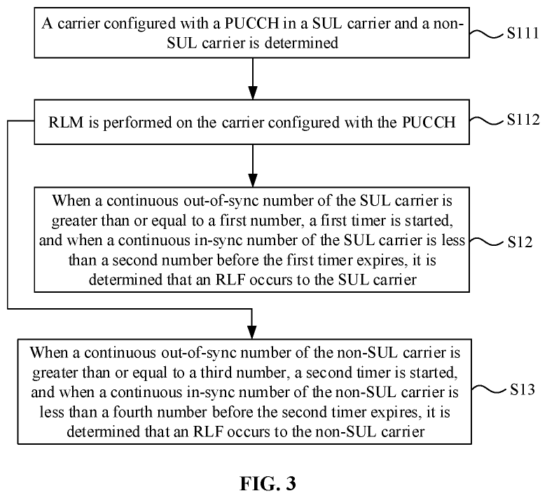

FIG. 3 is another schematic flow chart showing determination of an RLF, according to an example of the present disclosure. As illustrated in FIG. 3, based on the example illustrated in FIG. 2, the operation that the RLM is performed on the at least one of the SUL carrier or the non-SUL carrier includes the following steps.

In S111, a carrier configured with a PUCCH in the SUL carrier and the non-SUL carrier is determined.

In S112, the RLM is performed on the carrier configured with the PUCCH.

In one or more embodiments, only the carrier configured with the PUCCH in the SUL carrier and the non-SUL carrier may be monitored.

When no RLF occurs to the carrier configured with the PUCCH, the user equipment may transmit acknowledgement (ACK)/negative acknowledgement (NACK), channel quality indicator (CQI), precoding matrix indicator (PMI), rank indication (RI) and other information through the PUCCH, thereby implementing communication to a certain extent.

Therefore, only the carrier configured with the PUCCH is monitored, whether the RLF occurs to the carrier configured with the PUCCH is determined, and under the circumstance that the RLF occurs to the carrier configured with the PUCCH, processing may be performed (for example, S2 is executed) for communication. In such case, the carrier which is not configured with any PUCCH is not required to be monitored, and resources, occupied by a monitoring operation, of the user equipment are reduced.

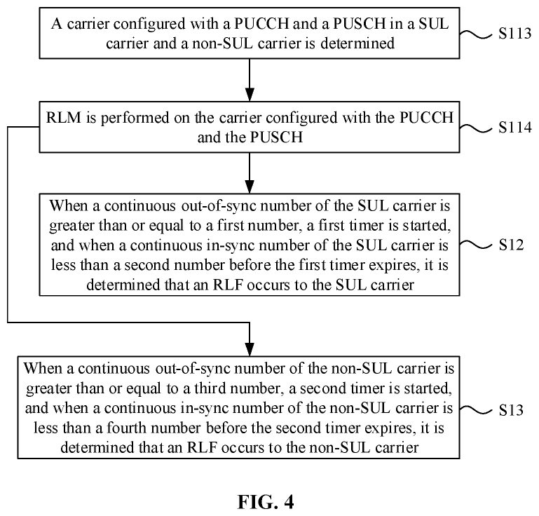

FIG. 4 is another schematic flow chart showing determination of an RLF, according to an example of the present disclosure. As illustrated in FIG. 4, based on the example illustrated in FIG. 2, the operation that the RLM is performed on the at least one of the SUL carrier or the non-SUL carrier includes the following steps.

In S113, a carrier configured with a PUCCH and a PUSCH in the SUL carrier and the non-SUL carrier is determined.

In S114, the RLM is performed on the carrier configured with the PUCCH and the PUSCH.

In one or more embodiments, only the carrier configured with the PUCCH and the PUSCH in the SUL carrier and the non-SUL carrier may be monitored.

When no RLF occurs to the carrier configured with the PUCCH and the PUSCH, the user equipment may transmit ACK/NACK, CQI, PMI, RI and other information through the PUCCH and transmit data through the PUSCH, thereby implementing normal communication.

Therefore, only the carrier configured with the PUCCH and the PUSCH is monitored, whether the RLF occurs to the carrier configured with the PUCCH and the PUSCH is determined, and under the circumstance that the RLF occurs to the carrier configured with the PUCCH and the PUSCH, processing may be performed (for example, S2 is executed) to ensure normal communication. In such case, the carrier which is not configured with either PUCCH or PUSCH is not required to be monitored, and resources, occupied by a monitoring operation, of the user equipment are reduced.

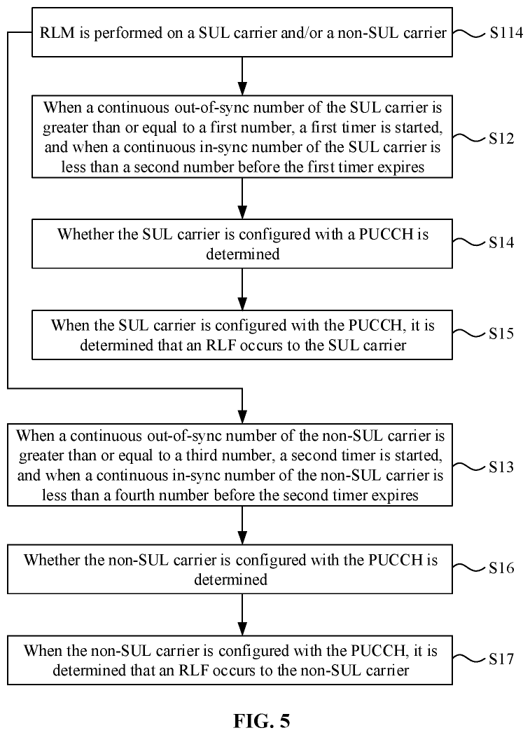

FIG. 5 is another schematic flow chart showing determination of an RLF, according to an example of the present disclosure. As illustrated in FIG. 5, based on the example illustrated in FIG. 2, when the continuous in-sync number of the SUL carrier is less than the second number, the operation that the at least one of whether the RLF occurs to the SUL carrier of the cell configured with the SUL carrier or whether the RLF occurs to the non-SUL carrier is determined further includes the following steps:

In S14, whether the SUL carrier is configured with a PUCCH is determined;

In S15, when the SUL carrier is configured with the PUCCH, it is determined that the RLF occurs to the SUL carrier; and/or

when the continuous in-sync number of the non-SUL carrier is less than the fourth number, the operation that the at least one of whether the RLF occurs to the SUL carrier of the cell configured with the SUL carrier or whether the RLF occurs to the non-SUL carrier is determined further includes the following steps:

In S16, whether the non-SUL carrier is configured with the PUCCH is determined;

In S17, when the non-SUL carrier is configured with the PUCCH, it is determined that the RLF occurs to the non-SUL carrier.

In one or more embodiments, based on the example illustrated in FIG. 2, for the SUL carrier, when the continuous in-sync number is less than the second number, whether the SUL carrier is configured with the PUCCH may further be determined, and under the circumstance that the SUL carrier is configured with the PUCCH, it is determined that the RLF occurs to the SUL carrier. Since communication of the user equipment may be influenced greatly only under the circumstance that the RLF occurs to the carrier configured with the PUCCH, for the SUL carrier which is not configured with the PUCCH, no processing may be performed (for example, S2 is not executed) even though the continuous in-sync number is less than the second number, thereby reducing occupied resources of the user equipment.

In one or more embodiments, based on the example illustrated in FIG. 2, for the non-SUL carrier, when the continuous in-sync number is less than the fourth number, whether the non-SUL carrier is configured with the PUCCH may further be determined, and under the circumstance that the non-SUL carrier is configured with the PUCCH, it is determined that the RLF occurs to the non-SUL carrier. Since communication of the user equipment may be influenced greatly only under the circumstance that the RLF occurs to the carrier configured with the PUCCH, for the non-SUL carrier which is not configured with the PUCCH, no processing may be performed (for example, S2 is not executed) even though the continuous in-sync number is less than the fourth number, thereby reducing occupied resources of the user equipment.

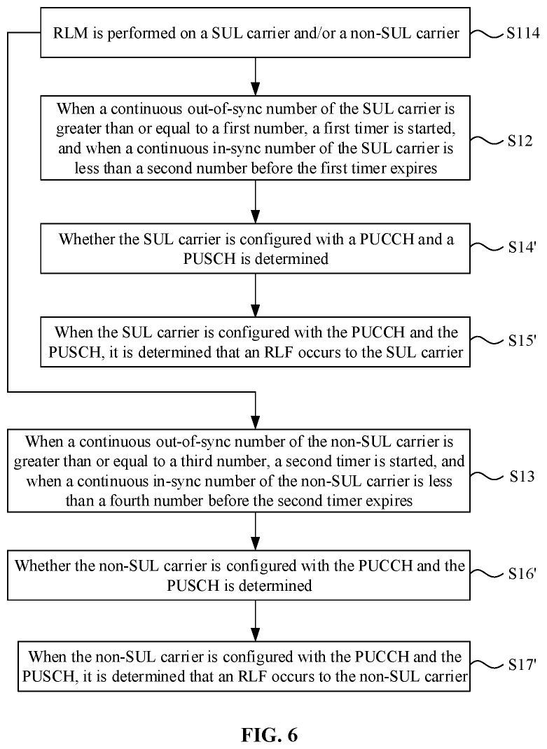

FIG. 6 is another schematic flow chart showing determination of an RLF, according to an example of the present disclosure. As illustrated in FIG. 6, based on the example illustrated in FIG. 2, when the continuous in-sync number of the SUL carrier is less than the second number, the operation that the at least one of whether the RLF occurs to the SUL carrier of the cell configured with the SUL carrier or whether the RLF occurs to the non-SUL carrier is determined further includes the following steps:

In S14′, whether the SUL carrier is configured with a PUCCH and a PUSCH is determined;

In S15′, when the SUL carrier is configured with the PUCCH and the PUSCH, it is determined that the RLF occurs to the SUL carrier; and/or

when the continuous in-sync number of the non-SUL carrier is less than the fourth number, the operation that the at least one of whether the RLF occurs to the SUL carrier of the cell configured with the SUL carrier or whether the RLF occurs to the non-SUL carrier is determined further includes the following steps:

In S16′, whether the non-SUL carrier is configured with the PUCCH and the PUSCH is determined;

In S17′, when the non-SUL carrier is configured with the PUCCH and the PUSCH, it is determined that the RLF occurs to the non-SUL carrier.

In one or more embodiments, based on the example illustrated in FIG. 2, for the SUL carrier, when the continuous in-sync number is less than the second number, whether the SUL carrier is configured with the PUCCH and the PUSCH may further be determined, and under the circumstance that the SUL carrier is configured with the PUCCH and the PUSCH, it is determined that the RLF occurs to the SUL carrier. Since communication of the user equipment may be influenced greatly only under the circumstance that the RLF occurs to the carrier configured with the PUCCH and the PUSCH, for the SUL carrier which is not configured with the PUCCH and the PUSCH, no processing may be performed (for example, S2 is not executed) even though the continuous in-sync number is less than the second number, thereby reducing occupied resources of the user equipment.

In one or more embodiments, based on the example illustrated in FIG. 2, for the non-SUL carrier, when the continuous in-sync number is less than the fourth number, whether the non-SUL carrier is configured with the PUCCH and the PUSCH may further be determined, and under the circumstance that the non-SUL carrier is configured with the PUCCH and the PUSCH, it is determined that the RLF occurs to the non-SUL carrier. Since communication of the user equipment may be influenced greatly only under the circumstance that the RLF occurs to the carrier configured with the PUCCH and the PUSCH, for the non-SUL carrier which is not configured with the PUCCH and the PUSCH, no processing may be performed (for example, S2 is not executed) even though the continuous in-sync number is less than the fourth number, thereby reducing occupied resources of the user equipment.

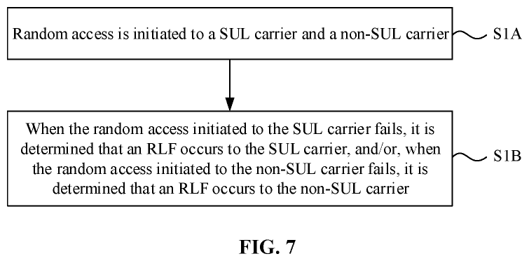

FIG. 7 is another schematic flow chart showing determination of an RLF, according to an example of the present disclosure. As illustrated in FIG. 7, based on the example illustrated in FIG. 1, the operation that the at least one of whether the RLF occurs to the SUL carrier of the cell configured with the SUL carrier or whether the RLF occurs to the non-SUL carrier is determined includes the following steps.

In S1A, random access is initiated to the SUL carrier and the non-SUL carrier.

In S1B, when the random access initiated to the SUL carrier fails, it is determined that the RLF occurs to the SUL carrier, and/or, when the random access initiated to the non-SUL carrier fails, it is determined that the RLF occurs to the non-SUL carrier.

In one or more embodiments, besides the monitoring manner for determining whether the RLF occurs to the carrier of the cell in the example illustrated in FIG. 2, random access may also be initiated to the carrier of the cell to determine whether the RLF occurs to the carrier.

When the random access initiated to the SUL carrier fails, it may be determined that the RLF occurs to the SUL carrier, and when the random access initiated to the non-SUL carrier fails, it may be determined that the RLF occurs to the non-SUL carrier.

In one or more embodiments, the user equipment may select to initiate random access to the SUL carrier, or initiate random access to the non-SUL carrier, or initiate random access to the SUL carrier and the non-SUL carrier respectively according to a configuration of a base station side or a configuration of a user equipment side.

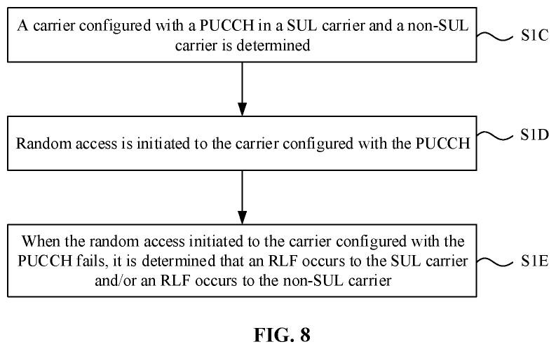

FIG. 8 is another schematic flow chart showing determination of an RLF, according to an example of the present disclosure. As illustrated in FIG. 8, based on the example illustrated in FIG. 1, the operation that the at least one of whether the RLF occurs to the SUL carrier of the cell configured with the SUL carrier or whether the RLF occurs to the non-SUL carrier is determined includes the following steps.

In S1C, a carrier configured with a PUCCH in the SUL carrier and the non-SUL carrier is determined.

In S1D, random access is initiated to the carrier configured with the PUCCH.

In S1E, when the random access initiated to the carrier configured with the PUCCH fails, it is determined that the RLF occurs to the at least one of the SUL carrier or the non-SUL carrier.

In one or more embodiments, the random access may be initiated to the carrier configured with the PUCCH in the SUL carrier and the non-SUL carrier only.

When no RLF occurs to the carrier configured with the PUCCH, the user equipment may transmit ACK/NACK, CQI, PMI, RI and other information through the PUCCH, thereby implementing communication to a certain extent.

Therefore, the random access is initiated to the carrier configured with the PUCCH only, whether the RLF occurs to the carrier configured with the PUCCH is determined, and under the circumstance that the RLF occurs to the carrier configured with the PUCCH, processing may be performed (for example, S2 is executed) so as to ensure communication to a certain extent. In such case, the random access is not required to be initiated to the carrier which is not configured with any PUCCH, and resources, occupied by an operation of initiating the random access, of the user equipment are reduced.

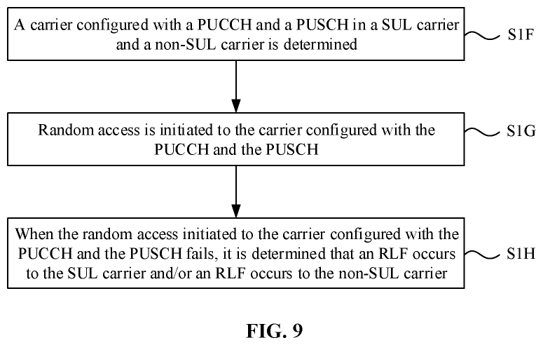

FIG. 9 is another schematic flow chart showing determination of an RLF, according to an example of the present disclosure. As illustrated in FIG. 9, based on the example illustrated in FIG. 1, the operation that the at least one of whether the RLF occurs to the SUL carrier of the cell configured with the SUL carrier or whether the RLF occurs to the non-SUL carrier is determined includes the following steps.

In S1F, a carrier configured with a PUCCH and a PUSCH in the SUL carrier and the non-SUL carrier is determined.

In S1G, random access is initiated to the carrier configured with the PUCCH and the PUSCH.

In S1H, when the random access initiated to the carrier configured with the PUCCH and the PUSCH fails, it is determined that the RLF occurs to the at least one of the SUL carrier or the non-SUL carrier.

In one or more embodiments, the random access may be initiated to the carrier configured with the PUCCH and the PUSCH in the SUL carrier and the non-SUL carrier only.

When no RLF occurs to the carrier configured with the PUCCH and the PUSCH, the user equipment may transmit ACK/NACK, CQI, PMI, RI and other information through the PUCCH and transmit data through the PUSCH, thereby implementing normal communication.

Therefore, the random access is initiated to the carrier configured with the PUCCH and the PUSCH only, whether the RLF occurs to the carrier configured with the PUCCH and the PUSCH is determined, and under the circumstance that the RLF occurs to the carrier configured with the PUCCH and the PUSCH, further processing may be performed (for example, S2 is executed) so as to ensure normal communication. In such case, the random access is not required to be initiated to the carrier which is not configured with either PUCCH or PUSCH. Therefore, user equipment resources, which are occupied by an operation of initiating the random access, are reduced.

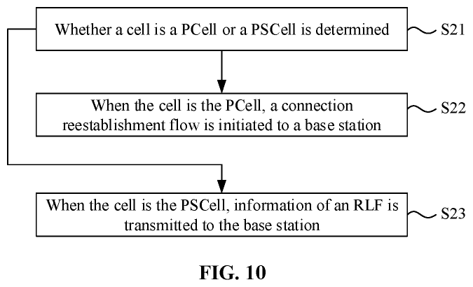

FIG. 10 is a schematic flow chart showing initiation of a connection reestablishment flow and/or transmission of information of an RLF to a base station, according to an example of the present disclosure. As illustrated in FIG. 10, based on the example illustrated in FIG. 1, the operation that the at least one of initiating the connection reestablishment flow or transmitting information of the RLF to the base station is performed includes the following steps.

In S21, whether the cell is a PCell or a PSCell is determined.

In S22, when the cell is the PCell, the connection reestablishment flow is initiated to the base station.

In S23, when the cell is the PSCell, the information of the RLF is transmitted to the base station.

In one or more embodiments, when it is determined that the RLF occurs to the cell configured with the SUL carrier, whether the cell is the PCell or the PSCell may further be determined, and when the cell is the PCell, the connection reestablishment flow may be initiated to the base station to enable the base station to recover a radio link of the PCell and ensure communication of the user equipment; and when the cell is the PSCell, the user equipment may still communicate through the radio link of the PCell, so that the information of the RLF is transmitted to the base station only, and the connection reestablishment flow is not required to be initiated.

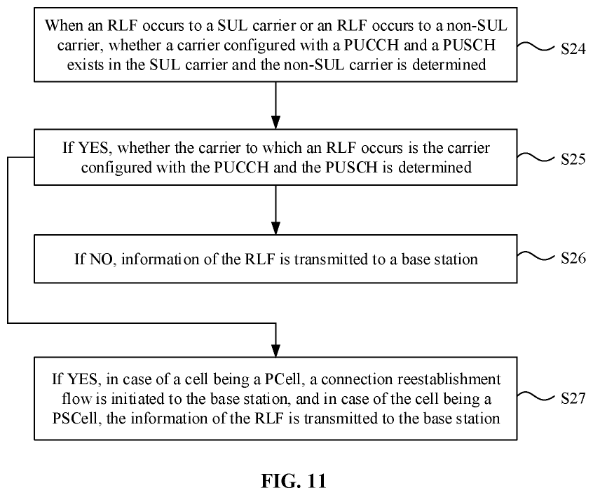

FIG. 11 is a schematic flow chart showing initiation of a connection reestablishment flow and/or transmission of information of an RLF to a base station, according to another example of the present disclosure. As illustrated in FIG. 11, based on the example illustrated in FIG. 1, the operation that the at least one of initiating the connection reestablishment flow or transmitting information of the RLF to the base station is performed includes the following steps.

In S24, when the RLF occurs to the SUL carrier or the RLF occurs to the non-SUL carrier, whether a carrier configured with a PUCCH and a PUSCH exists in the SUL carrier and the non-SUL carrier is determined.

In S25, if YES, whether the carrier to which the RLF occurs is the carrier configured with the PUCCH and the PUSCH is determined.

In S26, if NO, the information of the RLF is transmitted to the base station.

In S27, if YES, in case of the cell being a PCell, the connection reestablishment flow is initiated to the base station, and in case of the cell being a PSCell, the information of the RLF is transmitted to the base station.

In one or more embodiments, when it is determined that the RLF occurs to one of the SUL carrier and the non-SUL carrier, whether the carrier configured with the PUCCH and the PUSCH exists in the SUL carrier and the non-SUL carrier may be determined.

When the carrier configured with the PUCCH and the PUSCH exists, whether the carrier to which the RLF occurs is the carrier configured with the PUCCH and the PUSCH may further be determined.

When the RLF occurs to the carrier which is not configured with the PUCCH and the PUSCH, the user equipment may still communicate normally through the carrier configured with the PUCCH and the PUSCH, so that the connection reestablishment flow is not required to be initiated to the base station, and it is only necessary to transmit the information of the RLF to the base station.

When the RLF occurs to the carrier configured with the PUCCH and the PUSCH, the user equipment cannot communicate normally, so that the connection reestablishment flow may be initiated to the base station to enable the base station to recover a radio link of the carrier configured with the PUCCH and the PUSCH for the user equipment to communicate normally based on the carrier configured with the PUCCH and the PUSCH.

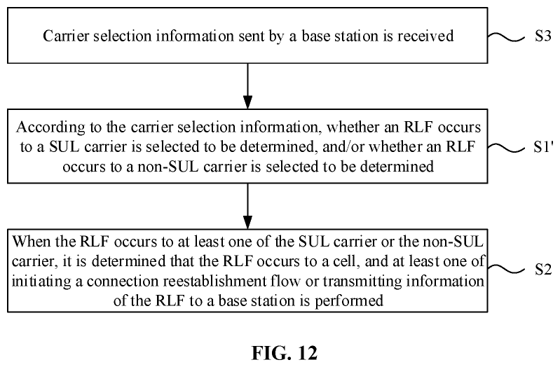

FIG. 12 is a schematic flow chart showing another radio link status determination method, according to an example of the present disclosure. As illustrated in FIG. 12, based on the example illustrated in FIG. 1, the radio link status determination method further includes the following step.

In S3, carrier selection information sent by the base station is received.

The operation that the at least one of whether the RLF occurs to the SUL carrier of the cell configured with the SUL carrier or whether the RLF occurs to the non-SUL carrier is determined includes the following step.

In S1′, according to the carrier selection information, the at least one of whether the RLF occurs to the SUL carrier or whether the RLF occurs to the non-SUL carrier is selected to be determined.

In one or more embodiments, the carrier selection information may be selecting to determine whether the RLF occurs to the SUL carrier, and in such case, the user equipment may determine whether the RLF occurs to the SUL carrier only.

Or, the carrier selection information may be determining whether the RLF occurs to the non-SUL carrier, and in such case, the user equipment may determine whether the RLF occurs to the non-SUL carrier only.

Or, the carrier selection information may be determining whether the RLF occurs to the SUL carrier and the non-SUL carrier respectively, and in such case, the user equipment may determine whether the RLF occurs to the SUL carrier and the non-SUL carrier respectively.

In one or more embodiments, the carrier selection information may be determining that the RLF occurs to the cell configured with the SUL carrier only when it is determined that the RLF occurs to the SUL carrier, and in such case, the user equipment determines that the RLF occurs to the cell only when determining that the RLF occurs to the SUL carrier.

Or, the carrier selection information may be determining that the RLF occurs to the cell configured with the SUL carrier only when it is determined that the RLF occurs to the non-SUL carrier, and in such case, the user equipment determines that the RLF occurs to the cell only when determining that the RLF occurs to the non-SUL carrier.

Or, the carrier selection information may be determining that the RLF occurs to the cell configured with the SUL carrier only when it is determined that the RLF occurs to both the SUL carrier and the non-SUL carrier, and in such case, the user equipment determines that the RLF occurs to the cell only when determining that the RLF occurs to the SUL carrier and the non-SUL carrier respectively.

In one or more embodiments, besides the contents illustrated in the abovementioned two examples, there may also other conditions for the carrier selection information. For example, it is determined that the RLF occurs to the cell configured with the SUL carrier only when it is determined that the RLF occurs to the carrier configured with the PUCCH and/or the PUSCH in the SUL carrier and the non-SUL carrier. The content of the carrier selection information may be set as required and will not be elaborated one by one herein.

Corresponding to the examples of the radio link status determination method, the present disclosure also provides examples of a radio link status determination device.

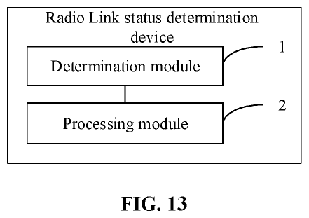

FIG. 13 is a schematic block diagram of a radio link status determination device, according to an example of the present disclosure. The radio link status determination device illustrated in the example may be applied to user equipment. As illustrated in FIG. 13, the radio link status determination device may include:

a determination module 1, configured to determine at least one of whether an RLF occurs to a SUL carrier of a cell configured with the SUL carrier or whether an RLF occurs to a non-SUL carrier; and

a processing module 2, configured to, when the RLF occurs to at least one of the SUL carrier or the non-SUL carrier, determine that the RLF occurs to the cell, and perform at least one of initiating a connection reestablishment flow or transmitting information of the RLF to a base station.

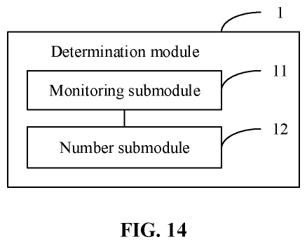

FIG. 14 is a schematic block diagram of a determination module, according to an exemplary example. As illustrated in FIG. 14, based on the example illustrated in FIG. 13, the determination module 1 includes:

a monitoring submodule 11, configured to perform RLM on the at least one of the SUL carrier or the non-SUL carrier; and

a number submodule 12, configured to, when a continuous out-of-sync number of the SUL carrier is greater than or equal to a first number, start a first timer, and when a continuous in-sync number of the SUL carrier is less than a second number before the first timer expires, determine that the RLF occurs to the SUL carrier, and/or

when a continuous out-of-sync number of the non-SUL carrier is greater than or equal to a third number, start a second timer, and when a continuous in-sync number of the non-SUL carrier is less than a fourth number before the second timer expires, determine that the RLF occurs to the non-SUL carrier.

Optionally, the monitoring submodule is configured to determine a carrier configured with a PUCCH in the SUL carrier and the non-SUL carrier, and perform the RLM on the carrier configured with the PUCCH.

Optionally, the monitoring submodule is configured to determine a carrier configured with a PUCCH and a PUSCH in the SUL carrier and the non-SUL carrier, and perform the RLM on the carrier configured with the PUCCH and the PUSCH.

Optionally, when the continuous in-sync number of the SUL carrier is less than the second number, the number submodule is further configured to determine whether the SUL carrier is configured with a PUCCH, and when the SUL carrier is configured with the PUCCH, determine that the RLF occurs to the SUL carrier,

and/or, when the continuous in-sync number of the non-SUL carrier is less than the fourth number, the number submodule is further configured to determine whether the non-SUL carrier is configured with the PUCCH, and when the non-SUL carrier is configured with the PUCCH, determine that the RLF occurs to the non-SUL carrier.

Optionally, when the continuous in-sync number of the SUL carrier is less than the second number, the number submodule is further configured to determine whether the SUL carrier is configured with a PUCCH and a PUSCH, and when the SUL carrier is configured with the PUCCH and the PUSCH, determine that the RLF occurs to the SUL carrier, and/or

when the continuous in-sync number of the non-SUL carrier is less than the fourth number, the number submodule is further configured to determine whether the non-SUL carrier is configured with the PUCCH and the PUSCH, and when the non-SUL carrier is configured with the PUCCH and the PUSCH, determine that the RLF occurs to the non-SUL carrier.

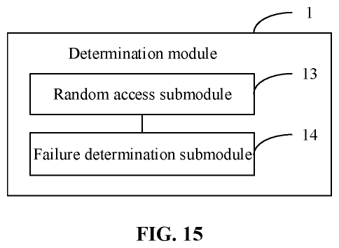

FIG. 15 is a schematic block diagram of another determination module, according to an exemplary example. As illustrated in FIG. 15, based on the example illustrated in FIG. 13, the determination module 1 includes:

a random access submodule 13, configured to initiate random access to the SUL carrier and the non-SUL carrier; and

a failure determination submodule 14, configured to, when the random access initiated to the SUL carrier fails, determine that the RLF occurs to the SUL carrier, and/or, when the random access initiated to the non-SUL carrier fails, determine that the RLF occurs to the non-SUL carrier.

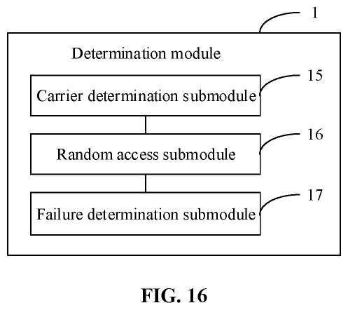

FIG. 16 is a schematic block diagram of another determination module, according to an example of the present disclosure. As illustrated in FIG. 16, based on the example illustrated in FIG. 13, the determination module 1 includes:

a carrier determination submodule 15, configured to determine a carrier configured with a PUCCH in the SUL carrier and the non-SUL carrier;

a random access submodule 16, configured to initiate random access to the carrier configured with the PUCCH; and

a failure determination submodule 17, configured to, when the random access initiated to the carrier configured with the PUCCH fails, determine that the RLF occurs to the at least one of the SUL carrier or the non-SUL carrier.

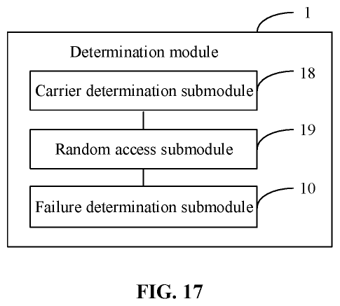

FIG. 17 is a schematic block diagram of another determination module, according to an example of the present disclosure. As illustrated in FIG. 17, based on the example illustrated in FIG. 13, the determination module 1 includes:

a carrier determination submodule 18, configured to determine a carrier configured with a PUCCH and a PUSCH in the SUL carrier and the non-SUL carrier;

a random access submodule 19, configured to initiate random access to the carrier configured with the PUCCH and the PUSCH; and

a failure determination submodule 10, configured to, when the random access initiated to the carrier configured with the PUCCH and the PUSCH fails, determine that the RLF occurs to the at least one of the SUL carrier or the non-SUL carrier.

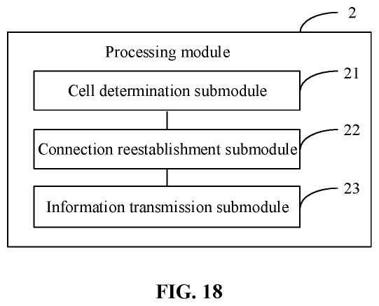

FIG. 18 is a schematic block diagram of a processing module, according to an example of the present disclosure. As illustrated in FIG. 18, based on the example illustrated in FIG. 13, the processing module 2 includes:

a cell determination submodule 21, configured to determine whether the cell is a PCell or a PSCell;

a connection reestablishment submodule 22, configured to, when the cell is the PCell, initiate the connection reestablishment flow to the base station; and

an information transmission submodule 23, configured to, when the cell is the PSCell, transmit the information of the RLF to the base station.

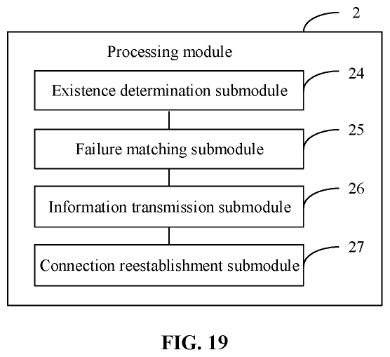

FIG. 19 is a schematic block diagram of another processing module, according to an example of the present disclosure. As illustrated in FIG. 19, based on the example illustrated in FIG. 13, the processing module 2 includes:

an existence determination submodule 24, configured to, when the RLF occurs to the SUL carrier or the RLF occurs to the non-SUL carrier, determine whether a carrier configured with a PUCCH and a PUSCH exists in the SUL carrier and the non-SUL carrier;

a failure matching submodule 25, configured to, when the carrier configured with the PUCCH and the PUSCH exists, determine whether the carrier to which the RLF occurs is the carrier configured with the PUCCH and the PUSCH;

an information transmission submodule 26, configured to, when the carrier to which the RLF occurs is not the carrier configured with the PUCCH and the PUSCH, transmit the information of the RLF to the base station, and when the carrier to which the RLF occurs is the carrier configured with the PUCCH and the PUSCH, in case of the cell being a PSCell, transmit the information of the RLF to the base station; and

a connection reestablishment submodule 27, configured to, when the carrier to which the RLF occurs is the carrier configured with the PUCCH and the PUSCH, in case of the cell being a PCell, initiate the connection reestablishment flow to the base station.

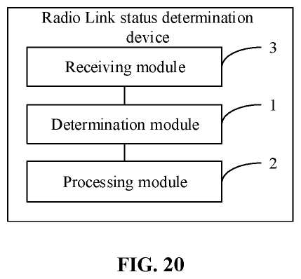

FIG. 20 is a schematic block diagram of another radio link status determination device, according to an example of the present disclosure. As illustrated in FIG. 20, based on the example illustrated in FIG. 13, the radio link status determination device further includes:

a receiving module 3, configured to receive carrier selection information sent by the base station.

The determination module 1 is configured to, according to the carrier selection information, select to determine the at least one of whether the RLF occurs to the SUL carrier or whether the RLF occurs to the non-SUL carrier.

With respect to the device in any one of the above examples, the specific manners for performing operations for individual modules therein have been described in detail in the method examples, which will not be elaborated herein.

The device examples substantially correspond to the method examples, and thus related parts refer to part of descriptions of the method examples. Each device example described above is only schematic, units described as separate parts therein may or may not be physically separated, and parts displayed as units may or may not be physical units, and namely may be located in the same place or may also be distributed to multiple network units. Part or all of the modules therein may be selected according to a practical requirement to achieve the purpose of the solutions of the examples. Those of ordinary skill in the art may understand and implement without creative work.

An example of the present disclosure also discloses an electronic device, which includes:

a processor; and

a memory configured to store instructions executable by the processor,

wherein the processor is configured to:

execute the steps in the method of any one of the examples in FIG. 1 to FIG. 12.

An example of the present disclosure also discloses a computer-readable storage medium, in which a computer program is stored, and the program is executed by a processor to implement the steps in the method of any one of the examples in FIG. 1 to FIG. 12.

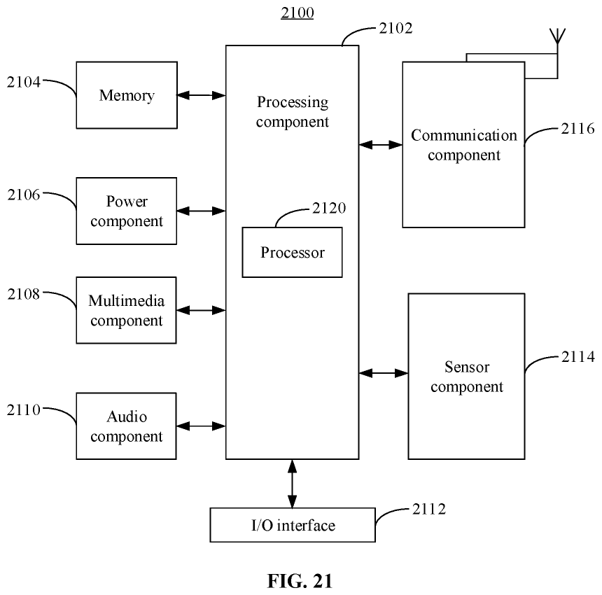

FIG. 21 is a schematic block diagram of a radio link status determination device 2100, according to an exemplary example. For example, the device 2100 may be a mobile phone, a computer, a digital broadcast terminal, a messaging device, a gaming console, a tablet, a medical device, exercise equipment, a personal digital assistant, and the like.

Referring to FIG. 21, the device 2100 may include one or more of the following components: a processing component 2102, a memory 2104, a power component 2106, a multimedia component 2108, an audio component 2110, an input/output (I/O) interface 2112, a sensor component 2114, and a communication component 2116.

The processing component 2102 typically controls overall operations of the device 2100, such as the operations associated with display, telephone calls, data communications, camera operations, and recording operations. The processing component 2102 may include one or more processors 2120 to execute instructions to perform all or part of the steps in the abovementioned method. Moreover, the processing component 2102 may include one or more modules which facilitate interaction between the processing component 2102 and other components. For instance, the processing component 2102 may include a multimedia module to facilitate interaction between the multimedia component 2108 and the processing component 2102.

The memory 2104 is configured to store various types of data to support the operation of the device 2100. Examples of such data include instructions for any applications or methods operated on the device 2100, contact data, phonebook data, messages, pictures, video, etc. The memory 2104 may be implemented by any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, and a magnetic or optical disk.

The power component 2106 provides power to various components of the device 2100. The power component 2106 may include a power management system, one or more power supplies, and other components associated with generation, management and distribution of power for the device 2100.

The multimedia component 2108 includes a screen providing an output interface between the device 2100 and a user. In some examples, the screen may include a liquid crystal display (LCD) and a touch panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also detect a period of time and a pressure associated with the touch or swipe action. In some examples, the multimedia component 2108 includes a front camera and/or a rear camera. The front camera and/or the rear camera may receive external multimedia data when the device 2100 is in an operation mode, such as a photographing mode or a video mode. Each of the front camera and the rear camera may be a fixed optical lens system or have focusing and optical zooming capabilities.

The audio component 2110 is configured to output and/or input an audio signal. For example, the audio component 2110 includes a microphone (MIC), and the MIC is configured to receive an external audio signal when the device 2100 is in an operation mode, such as a call mode, a recording mode and a voice recognition mode. The received audio signal may further be stored in the memory 2104 or sent through the communication component 2116. In some examples, the audio component 2110 further includes a speaker configured to output the audio signal.

The I/O interface 2112 provides an interface between the processing component 2102 and peripheral interface modules, such as a keyboard, a click wheel, buttons, and the like. The buttons may include, but are not limited to: a home button, a volume button, a starting button and a locking button.

The sensor component 2114 includes one or more sensors configured to provide status assessments of various aspects of the device 2100. For instance, the sensor component 2114 may detect an on/off status of the device 2100 and relative positioning of components, such as a display and small keyboard of the device 2100, and the sensor component 2114 may further detect a change in a position of the device 2100 or a component of the device 2100, presence or absence of contact between the user and the device 2100, orientation or acceleration/deceleration of the device 2100 and a change in temperature of the device 2100. The sensor component 2114 may include a proximity sensor configured to detect presence of an object nearby without any physical contact. The sensor component 2114 may also include a light sensor, such as a complementary metal oxide semiconductor (CMOS) or charge coupled device (CCD) image sensor, configured for use in an imaging application. In some examples, the sensor component 2114 may also include an acceleration sensor, a gyroscope sensor, a magnetic sensor, a pressure sensor or a temperature sensor.

The communication component 2116 is configured to facilitate wired or wireless communication between the device 2100 and other devices. The device 2100 may access a communication-standard-based wireless network, such as a wireless fidelity (WiFi) network, a 2nd-generation (2G) or 3rd-generation (3G) network or a combination thereof. In an exemplary example, the communication component 2116 receives a broadcast signal or broadcast associated information from an external broadcast management system through a broadcast channel. In an exemplary example, the communication component 2116 further includes a near field communication (NFC) module to facilitate short-range communications. For example, the NFC module may be implemented based on a radio frequency identification (RFID) technology, an infrared data association (IrDA) technology, an ultra-wide band (UWB) technology, a Bluetooth (BT) technology, and other technologies.

In an exemplary example, the device 2100 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic components, and is configured to execute the method of any example.

In an exemplary example, there is also provided a non-transitory computer-readable storage medium including instructions, such as included in the memory 2104 executable by the processor 2120 of the device 2100 for performing the abovementioned methods. For example, the non-transitory computer-readable storage medium may be a ROM, a random access memory (RAM), a compact disc read-only memory (CD-ROM), a magnetic tape, a floppy disc, an optical data storage device and the like.

Other implementation solutions of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

It is to be noted that relational terms “first”, “second” and the like in the present disclosure are adopted only to distinguish one entity or operation from another entity or operation and not always to require or imply existence of any such practical relationship or sequence between the entities or operations. Terms “include” and “have” or any other variation thereof is intended to cover nonexclusive inclusions, so that a process, method, object or device including a series of elements not only includes those elements, but also includes other elements that are not clearly listed, or further includes elements intrinsic to the process, the method, the object or the device. Under the condition of no more limitations, an element defined by statement “including a/an” does not exclude existence of another element that is the same in a process, method, object or device including the element.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The method and device provided in the examples of the present disclosure are introduced above in detail. The principle and implementation modes of the present disclosure are elaborated in the specification with specific examples. The examples are described above only to help the method of the present disclosure and the core concept thereof to be understood. In addition, those of ordinary skill in the art may make variations to the specific implementation modes and the scope of application according to the concept of the present disclosure. To sum up, the contents of the specification should not be understood as limits to the present disclosure.

What is claimed is:

1. A method for determining radio link status, comprising:
determining whether a radio link failure (RLF) occurs to at least one of a supplement uplink (SUL) carrier of a cell configured with the SUL carrier or a non-SUL carrier; and
in response to the RLF occurring to at least one of the SUL carrier or the non-SUL carrier, determining that the RLF occurs to the cell, performing at least one of initiating a connection reestablishment flow or transmitting information of the RLF to a base station.

2. The method of claim 1, wherein determining whether the RLF occurs to the at least one of the SUL carrier of the cell configured with the SUL carrier or the non-SUL carrier comprises:
performing radio link monitoring (RLM) on the at least one of the SUL carrier or the non-SUL carrier;
in response to a continuous out-of-sync number of the SUL carrier being greater than or equal to a first number, starting a first timer, and in response to a continuous in-sync number of the SUL carrier being less than a second number before the first timer expires, determining that the RLF occurs to the SUL carrier; and/or
in response to a continuous out-of-sync number of the non-SUL carrier being greater than or equal to a third number, starting a second timer, and in response to a continuous in-sync number of the non-SUL carrier being less than a fourth number before the second timer expires, determining that the RLF occurs to the non-SUL carrier.

3. The method of claim 2, wherein performing the RLM on the at least one of the SUL carrier or the non-SUL carrier comprises:
determining a carrier configured with a physical uplink control channel (PUCCH) in the SUL carrier and the non-SUL carrier; and
performing the RLM on the carrier configured with the PUCCH.

4. The method of claim 2, wherein performing the RLM on the at least one of the SUL carrier or the non-SUL carrier comprises:
determining a carrier configured with a PUCCH and a physical uplink shared channel (PUSCH) in the SUL carrier and the non-SUL carrier; and
performing the RLM on the carrier configured with the PUCCH and the PUSCH.

5. The method of claim 2, wherein, in response to the continuous in-sync number of the SUL carrier being less than the second number, the determining the at least one of whether the RLF occurs to the SUL carrier of the cell configured with the SUL carrier or whether the RLF occurs to the non-SUL carrier further comprises:
determining whether the SUL carrier is configured with a PUCCH, and
in response to the SUL carrier configured with the PUCCH, determining that the RLF occurs to the SUL carrier; and/or
in response to the continuous in-sync number of the non-SUL carrier being less than the fourth number, the determining the at least one of whether the RLF occurs to the SUL carrier of the cell configured with the SUL carrier or whether the RLF occurs to the non-SUL carrier further comprises:
determining whether the non-SUL carrier is configured with the PUCCH, and
in response to the non-SUL carrier configured with the PUCCH, determining that the RLF occurs to the non-SUL carrier.

6. The method of claim 2, wherein, in response to the continuous in-sync number of the SUL carrier being less than the second number, the determining the at least one of whether the RLF occurs to the SUL carrier of the cell configured with the SUL carrier or whether the RLF occurs to the non-SUL carrier further comprises:
determining whether the SUL carrier is configured with a PUCCH and a PUSCH, and
in response to the SUL carrier configured with the PUCCH and the PUSCH, determining that the RLF occurs to the SUL carrier; and/or
in response to the continuous in-sync number of the non-SUL carrier being less than the fourth number, the determining the at least one of whether the RLF occurs to the SUL carrier of the cell configured with the SUL carrier or whether the RLF occurs to the non-SUL carrier further comprises:
determining whether the non-SUL carrier is configured with the PUCCH and the PUSCH, and
in response to the non-SUL carrier configured with the PUCCH and the PUSCH, determining that the RLF occurs to the non-SUL carrier.

7. The method of claim 1, wherein determining the at least one of whether the RLF occurs to the SUL carrier of the cell configured with the SUL carrier or whether the RLF occurs to the non-SUL carrier comprises:
initiating random access to the SUL carrier and the non-SUL carrier; and
in response to the random access initiated to the SUL carrier failed, determining that the RLF occurs to the SUL carrier, and/or, when the random access initiated to the non-SUL carrier fails, determining that the RLF occurs to the non-SUL carrier.

8. The method of claim 1, wherein determining the at least one of whether the RLF occurs to the SUL carrier of the cell configured with the SUL carrier or whether the RLF occurs to the non-SUL carrier comprises:
determining a carrier configured with a PUCCH in the SUL carrier and the non-SUL carrier;
initiating random access to the carrier configured with the PUCCH; and
in response to the random access initiated to the carrier configured with the PUCCH failed, determining that the RLF occurs to the at least one of the SUL carrier or the non-SUL carrier.

9. The method of claim 1, wherein determining the at least one of whether the RLF occurs to the SUL carrier of the cell configured with the SUL carrier or whether the RLF occurs to the non-SUL carrier comprises:
determining a carrier configured with a PUCCH and a PUSCH in the SUL carrier and the non-SUL carrier;
initiating random access to the carrier configured with the PUCCH and the PUSCH; and
in response to the random access initiated to the carrier configured with the PUCCH and the PUSCH failed, determining that the RLF occurs to the at least one of the SUL carrier or the non-SUL carrier.

10. The method of claim 1, wherein performing the at least one of initiating the connection reestablishment flow or transmitting information of the RLF to the base station comprises:
in response to the RLF occurring to the SUL carrier or the non-SUL carrier, determining whether a carrier configured with a PUCCH and a PUSCH exists in the SUL carrier and the non-SUL carrier;
in response to the carrier configured with the PUCCH and the PUSCH existed, determining whether the carrier to which the RLF occurs is the carrier configured with the PUCCH and the PUSCH;
in response to the carrier to which the RLF occurs being not the carrier configured with the PUCCH and the PUSCH, transmitting the information of the RLF to the base station; and
in response to the carrier to which the RLF occurs being the carrier configured with the PUCCH and the PUSCH, in case of the cell being a PCell, initiating the connection reestablishment flow to the base station, and in case of the cell being a PSCell, transmitting the information of the RLF to the base station.

11. A device for determining radio link status, comprising:
a processor; and
a memory for storing instructions executable by the processor;
wherein the processor is configured to:
determine whether a radio link failure (RLF) occurs to at least one of a supplement uplink (SUL) carrier of a cell configured with the SUL carrier or a non-SUL carrier; and
in response to the RLF occurring to the at least one of the SUL carrier or the non-SUL carrier, determine that the RLF occurs to the cell, and perform the at least one of initiating a connection reestablishment flow or transmitting information of the RLF to a base station.

12. The device of claim 11, wherein the processor is further configured to:
perform radio link monitoring (RLM) on the at least one of the SUL carrier or the non-SUL carrier; and
in response to a continuous out-of-sync number of the SUL carrier being greater than or equal to a first number, start a first timer, and in response to a continuous in-sync number of the SUL carrier being less than a second number before the first timer expires, determine that the RLF occurs to the SUL carrier, and/or
in response to a continuous out-of-sync number of the non-SUL carrier being greater than or equal to a third number, start a second timer, and in response to a continuous in-sync number of the non-SUL carrier being less than a fourth number before the second timer expires, determine that the RLF occurs to the non-SUL carrier.

13. The device of claim 12, wherein the processor is configured to determine a carrier configured with a physical uplink control channel (PUCCH) in the SUL carrier and the non-SUL carrier, and perform the RLM on the carrier configured with the PUCCH.

14. The device of claim 12, wherein the processor is configured to determine a carrier configured with a PUCCH and a physical uplink shared channel (PUSCH) in the SUL carrier and the non-SUL carrier, and perform the RLM on the carrier configured with the PUCCH and the PUSCH.

15. The device of claim 12, wherein, in response to the continuous in-sync number of the SUL carrier being less than the second number, the processor is further configured to determine whether the SUL carrier is configured with a PUCCH, and in response to the SUL carrier configured with the PUCCH, determine that the RLF occurs to the SUL carrier,
and/or, in response to the continuous in-sync number of the non-SUL carrier being less than the fourth number, the processor is further configured to determine whether the non-SUL carrier is configured with the PUCCH, and in response to the non-SUL carrier configured with the PUCCH, determine that the RLF occurs to the non-SUL carrier.

16. The device of claim 12, wherein, in response to the continuous in-sync number of the SUL carrier being less than the second number, the processor is further configured to determine whether the SUL carrier is configured with a PUCCH and a PUSCH, and in response to the SUL carrier configured with the PUCCH and the PUSCH, determine that the RLF occurs to the SUL carrier, and/or
in response to the continuous in-sync number of the non-SUL carrier being less than the fourth number, the processor is further configured to determine whether the non-SUL carrier is configured with the PUCCH and the PUSCH, and in response to the non-SUL carrier configured with the PUCCH and the PUSCH, determine that the RLF occurs to the non-SUL carrier.

17. The device of claim 11, wherein the processor is further configured to:
initiate random access to the SUL carrier and the non-SUL carrier; and
in response to the random access initiated to the SUL carrier failed, determine that the RLF occurs to the SUL carrier, and/or, in response to the random access initiated to the non-SUL carrier failed, determine that the RLF occurs to the non-SUL carrier.

18. The device of claim 11, wherein the processor is further configured to:
determine a carrier configured with a PUCCH in the SUL carrier and the non-SUL carrier;
initiate random access to the carrier configured with the PUCCH; and
in response to the random access initiated to the carrier configured with the PUCCH failed, determine that the RLF occurs to the at least one of the SUL carrier or the non-SUL carrier.

19. The device of claim 11, wherein the processor is further configured to:
determine a carrier configured with a PUCCH and a PUSCH in the SUL carrier and the non-SUL carrier;
initiate random access to the carrier configured with the PUCCH and the PUSCH; and
in response to the random access initiated to the carrier configured with the PUCCH and the PUSCH failed, determine that the RLF occurs to the at least one of the SUL carrier or the non-SUL carrier.

20. The device of claim 11, wherein the processor is further configured to:
in response to the RLF occurring to the SUL carrier or the non-SUL carrier, determine whether a carrier configured with a PUCCH and a PUSCH exists in the SUL carrier and the non-SUL carrier;
in response to the carrier configured with the PUCCH and the PUSCH existed, determine whether the carrier to which the RLF occurs is the carrier configured with the PUCCH and the PUSCH;
in response to the carrier to which the RLF occurs is not the carrier configured with the PUCCH and the PUSCH, transmit the information of the RLF to the base station, and in response to the carrier to which the RLF occurs being the carrier configured with the PUCCH and the PUSCH, in case of the cell being a PSCell, transmit the information of the RLF to the base station; and
in response to the carrier to which the RLF occurs being the carrier configured with the PUCCH and the PUSCH, in case of the cell being a PCell, initiate the connection reestablishment flow to the base station.
